(19) United States
(12) Patent Application Publication
(10) Pub. No.: US 2022/0009166 A1
(43) Pub. Date: Jan. 13, 2022

(54) WORKPIECE SUPPORT SYSTEM

(71) Applicant: BigRep GmbH, Berlin (DE)

(72) Inventor: Andreas DIEHR, Berlin (DE)

(73) Assignee: BigRep GmbH, Berlin (DE)

(21) Appl. No.: 17/293,120

(22) PCT Filed: Nov. 12, 2019
(86) PCT No.: PCT/EP2019/080987

§ 371 Date: May 12, 2021

(30) Foreign Application Priority Data
Nov. 12, 2018 (LU) LU101001

(51) Int. Cl. B29C 64/245; B29C 64/227

(52) U.S. Cl. CPC B29C 64/245; B33Y 30/00; B29C 64/227

(57) ABSTRACT

A workpiece support system for an additive manufacturing device comprises a workpiece support and a motion system, wherein the workpiece support being connected to the motion system such that it can be detached tool-fee.

### FIELD

The present disclosure refers to the field of additive manufacturing processes or the so called 3D-printing. In particular, the present disclosure refers to a workpiece support system, respectively, a movable print bed for an additive manufacturing device, respectively, a so called 3D-printer.

### BACKGROUND

With additive manufacturing a workpiece is built up by layer wise material deposition on a build platform, respectively, a workpiece support or also a print bed. All plastic and metal materials known in the prior art can be considered. Processes using plastics for building a workpiece for example FFF (fused filament fabrication) and SLA (stereolithography) can be considered.

Usually, the built workpieces will be extracted manually from the additive manufacturing device from a print bed, respectively, from a workpiece support. Further, it is known that workpieces are built on a mat, respectively, a foil and said mat, respectively, said foil is extracted manually from the additive manufacturing device together with the workpiece.

### OVERVIEW

In view of an increased user friendliness and an automated processing e.g. in so called printer farms it is desirable and an objective of the present disclosure that the workpiece extraction is simplified.

The above objective is attained by an apparatus according to the appended independent claims. Selected embodiments, respectively, selected features are subject of the respective dependent claims, which represent each or in different combinations with each other embodiments of the invention.

According to an aspect of the present disclosure a workpiece support system for an additive manufacturing device comprises a workpiece support and a motion system. The workpiece support is connected to the motion system and the connection is tool-free releasable. A motion system according to this disclosure is understood as a system for moving the workpiece support not having the function of a manufacturing axis of the additive manufacturing device. Usually, manufacturing axes are understood as being the x, y and z-axes of the additive manufacturing device, that for example move a printhead and/or the workpiece support of the additive manufacturing device during the build of the workpiece, respectively, for building the workpiece. The manufacturing axes may comprise multiple guidings, respectively, may comprise multiple drives, this may be for example known portal systems, respectively, linear systems. For example, the motion system may comprise two apparatuses that are located parallel to two edges of the workpiece support.

The motion system is tasked with moving the workpiece support such that the extraction of a workpiece located on the workpiece support is easier. Further, by means of the tool-free and releasable connection between the motion system and the workpiece support, the workpiece support can be taken away completely as well as effortlessly from the additive manufacturing device. For example, this may be favourable for an automatic extraction in a printer farm in order to establish an automatic process within the printer farm. Further, the extraction of the workpiece support may be favourable for a high machine utilization of the additive manufacturing device as a first workpiece support with at least one workpiece may be extracted and a second empty workpiece support may be inserted into the additive manufacturing device without time consumingly taking off the at least one workpiece off the first workpiece support and preparing the first workpiece support for the next print.

According to a further aspect of the present disclosure the motion system of the workpiece support system may comprise a telescopic system. This is favourable as space in an additive manufacturing device may be saved as the motion system may be kept small in its dimensions.

According to a further aspect of the present disclosure the motion system may move the workpiece support from a processing position to a travel position. This may be favourable as for example the workpiece support may be coupled in the processing position to at least one of the above mentioned manufacturing axes of the additive manufacturing device and the motion system does not permanently have to bear the load of the workpiece supports. Further, it may be favourable that the workpiece support is in a precisely defined processing position in the additive manufacturing device, hence different workpiece supports can be positioned always in the same position in the additive manufacturing device and thus a consistent quality of the workpieces can be ensured.

For this disclosure the following positions are defined: the processing position, see above. An extended position in which the workpiece support is moved out, respectively, moved to the outside of the additive manufacturing device by the motion system such that a workpiece, respectively, the workpiece support can be extracted or take away. A retracted position, in which the workpiece support and the motion system are located in total in the additive manufacturing device.

According to a further aspect of the present disclosure the workpiece support may be held to the motion system and/or in the above mentioned processing position by form fit. This is favourable as the connection between the motion system and the workpiece support can be designed in a simple manner. Further, for example a precisely defined position of the workpiece support with regard to the motion system is possible.

According to a further aspect of the present disclosure the workpiece support may be held by gravity to the motion system and/or in the above mentioned processing position. This is favourable as a simple connection is possible that is easy to separate.

According to a further aspect of the present disclosure the workpiece support of the workpiece support system can be held at multiple points to the motion system and/or in the above mentioned processing position. At the same time only one of said points is a connection free of play. This is favourable as the workpiece support is connected free of play at one point with the motion system and/or is held in the processing position, however, is connected with play with the motion system at the other points, respectively, is held in the processing position. Hence, the workpiece support, respectively, the processing position can move with respect to the motion system e.g. due to temperature-caused expansion of the workpiece support and thus a jamming for example can be avoided.

According to a further aspect of the present disclosure the workpiece support can further comprise a heating. This is favourable as the quality of the workpieces can be improved as no thermal energy is unwantedly and disadvantageously drawn from a deposited material from which the workpiece is built to the workpiece support.

According to a further aspect of the present disclosure the workpiece support system can comprise an electrical connection between the workpiece support and the motion system. This is favourable as for example an electric heating in the workpiece support does not have to be supplied by a battery (which would be also possible) with electricity, but can be supplied with electricity and thus be controlled from/by the additive manufacturing device. Further, a locking mechanism can be controlled via such a connection, wherein the locking mechanism locks the workpiece support with the motion system and/or a manufacturing axis.

According to a further aspect of the present disclosure the workpiece support can further comprise an identification unit. This is favourable as for example information regarding the workpiece support, the workpiece, the print job can be stored and can be retrieved e.g. wirelessly.

According to a further aspect of the present disclosure the workpiece support can further comprise reception points. This is favourable as for example the workpiece support can be attached to a crane and/or can be picked up from a trolley, respectively, a load carrier. Such load carriers can be known automatic load carriers that for example pick up the workpiece support from underneath and lift it out of the motion system.

According to another aspect of the present disclosure an additive manufacturing device can comprise a workpiece support system according to any of the above mentioned aspects and further comprise a door. At the same time the motion system can move the workpiece support through the opened door from the inside space of the additive manufacturing device to the outside. This is favourable as an user can easily get to the built workpiece(s). Further, this is favourable as the workpiece support can easily be extracted from the additive manufacturing device.

According to a further aspect of the present disclosure the workpiece support can be electrically connected via a releasable connection with the additive manufacturing device. This is favourable as the additive manufacturing device can control electrical devices that are located on the workpiece support, respectively, support them with electricity. This may be for example a heating or a micro-computer unit with wireless communication or an identification unit, where applicable.

According to a further aspect of the present disclosure the additive manufacturing device can further comprise an additional door and the workpiece support can also be moved through the opened additional door from the inside space of the additive manufacturing device to the outside. This is favourable as an empty workpiece support can be inserted from one side to the additive manufacturing device and then can be extracted from the other side through the additional door from the additive manufacturing device when the workpiece is completed.

According to a further aspect of the present disclosure at least one of the manufacturing axes of the additive manufacturing device can lift the workpiece support from the motion system from a travel position in the processing position. This may for example be the case in the retracted position. This may be favourable as the motion system only has to be movable parallel to one direction and thus can be designed simpler.

According to a further aspect of the present disclosure the workpiece support of an additive manufacturing device can comprise first and second connection points, wherein the first connection points are supposed for engagement with the motion system and the second connection points are supposed for engagement with a manufacturing axis of the additive manufacturing device. This may be favourable as the motion system only has to move parallel to one axis and thus can be designed simpler.

Above features can be freely combined with each other, as long as it is technically possible. The features of the workpiece support systems can be used in an additive manufacturing device and the features of the additive manufacturing device can be used with a workpiece support system.

### SHORT DESCRIPTION OF THE FIGURES

Further advantages and characteristics of the disclosure will be apparent from the following description of a preferred embodiment of the disclosure with reference to the appended figures which is given for illustration only and not for limiting purposes; in which:

FIG. 1 schematically shows an additive manufacturing device.

FIG. 2 schematically shows a detail of a workpiece support systems of an additive manufacturing device.

### DESCRIPTION OF THE EMBODIMENT

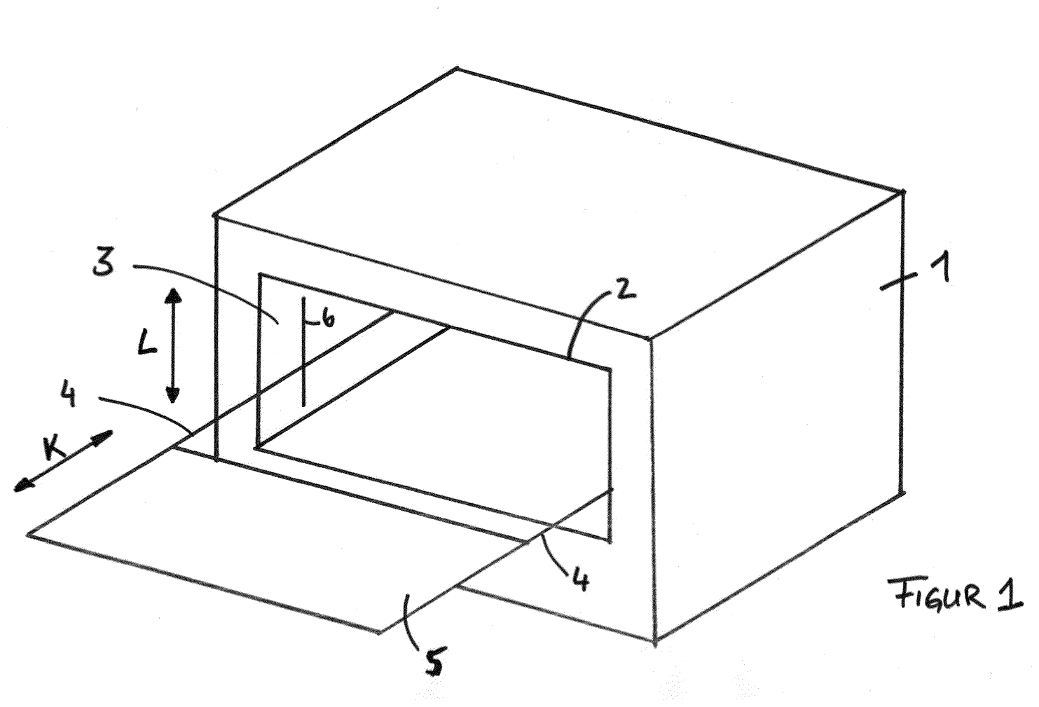

With reference to FIG. 1 an additive manufacturing device 1 is shown which has an opening 2 of a build space 3 and a workpiece support system. In the build space 3 a motion system 4 is located which is connected to a workpiece support 5. In FIG. 1 the extended position of the workpiece supports 5 is depicted. In a retracted position, the workpiece support system at least comprising the motion system 4 and the workpiece support 5, is completely located in the build space 3 such that at least one door (not shown) can close the opening 2. The door can for example firstly move to the outside and then secondly to one of the sides (up, down, left, right) for opening. Also, a pivoting mechanism may be used that pivots the door to one of the sides. In the processing position the manufacturing axes 6 (only one visible in FIG. 1) move the workpiece support parallel to arrow L for building a workpiece.

In the depicted embodiment the motion system 4 essentially comprises two telescopic rails arranged on both sides of the workpiece support 5. The workpiece support 5 is connected at connection points to the motion system 4 which are not shown in FIG. 1. The motion system 4 moves the workpiece support parallel to arrow K in FIG. 1, which is essentially parallel to e.g. the in FIG. 1 visible lower surface of the build space 3. Thus the workpiece support 5 can be moved in and out from/to the build space 3.

In the depicted embodiment the motion system 4 moves the workpiece support 5 from the extended position depicted in FIG. 1 in the direction parallel to arrow K into the build space 3 such that the motion system 4 and the workpiece support 5 are completely located in the build space 3 (travel position). Then the motion system 4 lowers itself parallel to arrow L wherein the workpiece support 5 also lowers itself accordingly until it engages with not shown reception points and is held there. This is the processing position of the workpiece support 5. In the processing position the workpiece support is detached from the motion system and may be moved by a system of axes of the additive manufacturing device 1 for building the workpiece.

A proceeding with the apparatus shown in FIG. 1 may be executed as follows. After finishing the 3D print the motion system 4 moves upwards parallel to arrow L and lifts the workpiece support 5 from the processing position to the travel position. Then the motion system 4 moves the workpiece support 5 parallel to arrow K out of the build space 3 to the outside of the additive manufacturing device 1. There the workpiece support can be extracted by means of not shown reception points form the motion system 4. This may be achieved e.g. by lifting from beneath or by lifting from above. The motion system 4 and/or the workpiece support 5 can comprise devices that detect when the workpiece support 5 is detached from the motion system 4 in the extended position such that controls of the additive manufacturing device 1 automatically retract the motion system and close a door of the build space 3 if the presence of the workpiece supports is not detected. Different waiting times may be provided. Independently a button may be provided on the motion system 4 that is operatively coupled to the controls of the additive manufacturing device.

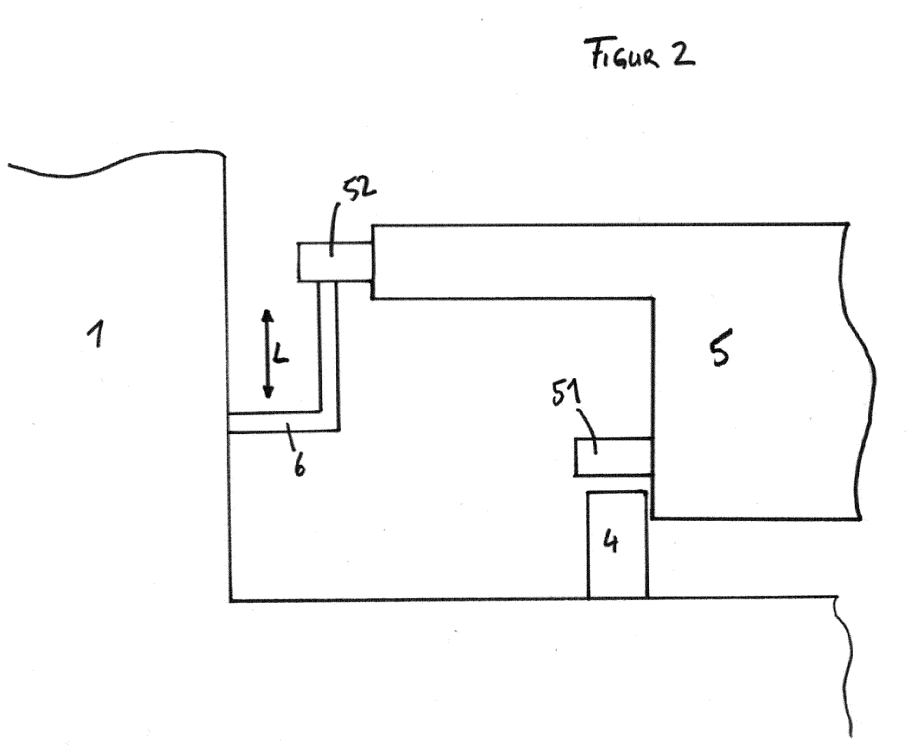

FIG. 2 depicts an alternative detail of a workpiece support systems of an additive manufacturing device 1. The workpiece support 5 is depicted in the retracted position as well as in the processing position. At the same time the workpiece support 5 is connected to a manufacturing axis 6 of the additive manufacturing device 1 at a second connection point 52. The manufacturing axis 6 is movable in parallel to arrow L. A first connection point 51 is located in the direction of the arrow L above the motion system 4. The apparatus depicted in FIG. 2 is also located mirror-inverted on the opposite side of the workpiece support 5. There can be four of the depicted apparatuses located on the workpiece support 5, preferably and respectively two of the apparatuses on opposing sides of the workpiece support 5.

If the motion system 4 of the embodiment of the workpiece support 5 depicted in FIG. 2 is moved from the exemplary depicted extracted position in FIG. 1 to the retracted position, the first connection point 51 is in contact with the motion system 4 and the manufacturing axis 6 is without contact with the second connection point 52. In particular, the manufacturing axis 6 is located underneath the second connection point 52. In the retracted position, the manufacturing axis 6 lifts the workpiece support 5 by means of the second connection point 52 upwards in parallel to the direction of arrow L. By means of said lifting the first connection point 51 disengages from the motion system 4 and the manufacturing axis 6 lifts the workpiece support 5 of the second connection point 52 in die processing position.

After building the workpiece, the manufacturing axis 6 lowers the workpiece support 5 via the second connection point 52 in parallel to arrow L until the first connection point 51 gets in contact with the motion system 4 and the second connection point 52 disengages from the manufacturing axis 6 (travel position). The motion system 4 then can move the workpiece support 5 to the outside of the additive manufacturing device (in parallel to arrow K in FIG. 1).

The connection between the first connection point 51 and the motion system 4 and/or the second connection point 52 and the manufacturing axis 6 is a form fit connection with the apparatus depicted in FIG. 2 that uses gravity. The first and second connection points 51 and 52 may be optionally be designed self-centring such that they centre themselves in the respective receiving points in the motion system 4 and/or the manufacturing axis 6. Also the reception points in the motion system 4 and/or the manufacturing axis 6 can be designed self-centring.

1. A workpiece support system for an additive manufacturing device comprising: a workpiece support and a motion system, wherein the workpiece support is connected with the motion system and the connection is tool-free releasable.

2. The workpiece support system according to claim 1, wherein the motion system comprises a telescopic system.

3. The workpiece support system according to claim 1, wherein the motion system moves the workpiece support from a processing position into a travel position.

4. The workpiece support system according to claim 1, wherein the workpiece support is held by form fit to the motion system and/or in a processing position.

5. The workpiece support system according to claim 4, wherein the workpiece support is held by gravity to the motion system and/or in a processing position.

6. The workpiece support system according to claim 1, wherein the workpiece support further comprises a heating.

7. The workpiece support system according to claim 1, wherein the workpiece support is held at multiple points to the motion system and/or in a processing position, and wherein only one of said point is a connection free of play.

8. The workpiece support system according to claim 1, further comprising an electrical connection between the workpiece support and the motion system.

9. The workpiece support system according to claim 1, wherein the workpiece support further comprises an identification unit.

10. The workpiece support system according to claim 1, wherein the workpiece support further comprises reception points.

11. An additive manufacturing device comprising a workpiece support system according to claim 1 and a door, wherein the motion system can move the workpiece support through the opened door from the inside space of the additive manufacturing device to the outside.

12. The additive manufacturing device according to claim 11, wherein the workpiece support is electrically connected via a detachable connection with the additive manufacturing device.

13. The additive manufacturing device according to claim 11, wherein the additive manufacturing device has another door and the workpiece support can be moved also through the other door from the inside space of the additive manufacturing device to the outside.

14. The additive manufacturing device according to claim 11, wherein at least one manufacturing axis of the additive manufacturing device lifts the workpiece support from the motion system into a processing position.

15. The additive manufacturing device according to claim 11, wherein the workpiece support comprises first and second connection points, wherein the first connection points are supposed for engagement with the motion system and the second connection points are supposed for engagement with a manufacturing axis of the additive manufacturing device.
